(19) United States
(12) Patent Application Publication
(10) Pub. No.: US 2015/0341696 A1
(43) Pub. Date: Nov. 26, 2015

(54) DUAL TELEPRESENCE SET-TOP BOX

(71) Applicants: William Gibbens REDMANN, Glendale, CA (US); Mark J. HUBER, Burbank, CA (US); Mark Leroy WALKER, Castaic, CA (US)

(72) Inventors: William Gibbens REDMANN, Glendale, CA (US); Mark J. HUBER, Burbank, CA (US); Mark Leroy WALKER, Castaic, CA (US)

(73) Assignee: Thomson Licensing, N/A (FR)

(21) Appl. No.: 14/758,684

(22) PCT Filed: Feb. 4, 2013
(86) PCT No.: PCT/US13/24614

§ 371 Date: Jun. 30, 2015

(51) Int. Cl. H04N 21/4788; H04N 21/41; H04N 21/44; H04N 21/431; H04N 7/14; H04N 7/15; G06F 17/30; H04N 21/4223

(52) U.S. Cl. CPC H04N 21/4788; G06F 17/30256; H04N 21/4122; H04N 21/4223; H04N 21/4312; H04N 7/144; H04N 7/15; H04N 21/44008

(57) ABSTRACT

The processing images in a telepresence system commences by establishing, at a first station, first orientation data indicative of an orientation of a first audience member relative to each of a first and second image display devices at the first station. Thereafter, the first station receives an incoming first image of a second audience member at a second station of the telepresence system, along with second orientation data indicative of an orientation of the second audience member relative to a first image capture device at the second station. The first station processes the first image for display on a selected one of the first and second image display devices, in accordance with the first and second orientation data so upon display, the image of the second audience appears to coexist in superposition with an image of the first audience member in a common environment.

### TECHNICAL FIELD

This invention relates to a technique for achieving improved image display in a telepresence system.

### BACKGROUND ART

In the early days of radio and television, a small number of nationwide networks transmitted content for contemporaneous consumption by large audiences, thereby providing a common cultural experience shared by large segments of the population. Now, content consumers have many choices. Content consumers today can record content for time-shifted viewing or can view stored content on demand. Thus, the wide variety of content choices available to consumers has substantially diluted the common cultural experience of watching content simultaneously with many other members of the same audience. Other than sharing recommendations for movies or television shows, content consumers now have substantially less opportunity to consume news and entertainment within their social network at substantially the same time.

Various efforts approaches currently exist for shared content consumption. Such approaches include:
U.S. Pat. No. 6,653,345 to Redmann et al. and U.S. Pat. No. 7,318,051 to Redmann both disclose a distributed musical performance system that includes a distributed transport control. Both patents describe techniques for executing commands to play, pause, rewind, fast-forward, and stop media playback in substantial synchronization at each location, regardless of latency in the network connection.
The cable news network CNN Online integrated a video feed of President Obama's first inauguration with a parallel Facebook-based feed, so that viewers could see comments made by their friends in real-time. This effort resulted in video that was not synchronized for all viewers, so some comments would appear long before a viewers saw the corresponding events, or long afterwards.
A company called frog design inc. currently provides an iPhone application called tvChatter that uses Twitter as a background service for collecting and redistributing contemporaneous commentary for live broadcasts of new television episodes. This application can spoil the outcome of a television show to a viewer for later viewing if that viewer receives comments for the same show from viewers who viewed the show at an earlier time.
The Microsoft Xbox 360 implementation of the Netflix movie streaming application offers the option to “Watch with Party”. Once a Netflix and Xbox Live account holder has logged in, the account holder's Xbox Live avatar becomes the viewer's on-screen persona. The user can select “Start Party” and invite other currently online, Xbox Live and Netflix subscribers to join the party (both remain necessary). A viewer can select movies the regular Netflix catalog by browsing posters in hierarchical arrangement (e.g., by theme, by genre, by rating, by similarity to other movies, etc.). Movies selected by party members appear as suggestions. After a viewer has selected a suggested movie, movie play out begins to test the communication channel bandwidth for video quality. An on-screen image of a theatrical venue appears, and the party members' avatars enter and take seats. The movie begins playing on the screen within the simulated theatrical venue. The viewers can direct their avatars to “emote” by selecting one of eight or so choices, in response to which, the user's avatar will make arm gesture and mime catcalls or cheers. This application has an available transport control that allows viewer the ability to pause, rewind, fast-forward or resume play out of the view all of the party members' platforms.
Present day video conference facilities offer one or more video screens and image capture devices, where a panel of participants in one environment will “meet” with one or more participants at remote locations. Such facilities permit sharing of presentations (e.g., PowerPoint® slides) and such facilities often include image capture devices for sharing images of physical documents. Cisco Systems, among others, sells image capture devices, monitors, lighting systems and video networking gear to equip such video conference facilities. Cisco has also published a telepresence interoperability protocol (TIP) to improve the ability of such facilities to interoperate with facilities comprising equipment from different manufacturers. The Internet Engineering Task Force (IETF) has undertaken to study a more general but competing standard “ControLling mUltiple streams for tElepresence” (CLUE) with initial data gathering beginning in January 2011 and continuing currently.
International Patent Application PCT/US 11/063036, having common inventorship with the instant application, describes a telepresence system in which each telepresence station has two monitors. The first monitor at each station displays content for synchronous viewing at one or more other stations within the telepresence system. The second monitor, together with a co-located an image capture, typically lie to one side of the first monitor. The second monitor serves to display the image of remote participant at another station of the telepresence system. In a case where the telepresence image capture device for the remote participant has an orientation such that its captured image, when displayed on the local telepresence monitor, shows the remote participant looking away from the local program monitor, the controller at the local station will flip the image of the remote participant horizontally, thereby improving the illusion of a shared environment.
   The above-described approaches to content sharing do not address the problem of how to manage the images of remote audience members in communication with each other via a telepresence system, so when they appear on viewing screens of local participants the remote audience members appear to exist in a common space, when one or more of the audience members has more than one telepresence monitor with image capture device.

### BRIEF SUMMARY OF THE INVENTION

Briefly, in accordance with a preferred embodiment of the present principles, a method for processing images in a telepresence system commences by establishing, at a first station within the telepresence system, first orientation data indicative of an orientation of a first audience member relative to each of a first and second image display devices at the first station. Thereafter, the first station receives an incoming first image of a second audience member at a second station of the telepresence system, along with second orientation data indicative of an orientation of the second audience member relative to a first image capture device at the second station. The first station processes the first image for display on a selected one of the first and second image display devices, in accordance with the first and second orientation data so that upon display of the first image, the second audience member appears to coexist with the first audience member in a common environment, whereby a persuasive telepresence illusion is created.

### BRIEF SUMMARY OF THE DRAWINGS

FIG. 1 depicts a block diagram of a telepresence system having two stations, each accomplishing display of simultaneous video content and display of remote audience members, in accordance with the present principles;

FIG. 2 depicts a block diagram of a telepresence system having three stations, each accomplishing display of simultaneous video content and display of remote audience members, in accordance with the present principles;

FIG. 3 depicts a set of images that illustrate the operation of the telepresence system of FIG. 2;

FIG. 4 depicts a flowchart of an exemplary process practiced by a local station of the telepresence systems of FIGS. 1 and 2 for preparing images for display received from a remote station of the telepresence system;

FIG. 5 depicts a flowchart of an exemplary process practiced by a local station of the telepresence systems of FIGS. 1 and 2 for preparing for display images for transmission to a remote station of the telepresence system;

FIG. 6 depicts a block diagram showing an exemplary set top box (STB) at a station of the telepresence system of FIGS. 1 and 2 for controlling first and second display devices at the station; and,

FIG. 7 depicts a block diagram showing another exemplary STB at a station of the telepresence system FIGS. 1 and 2 for controlling a single display device at the station;

### DETAILED DESCRIPTION

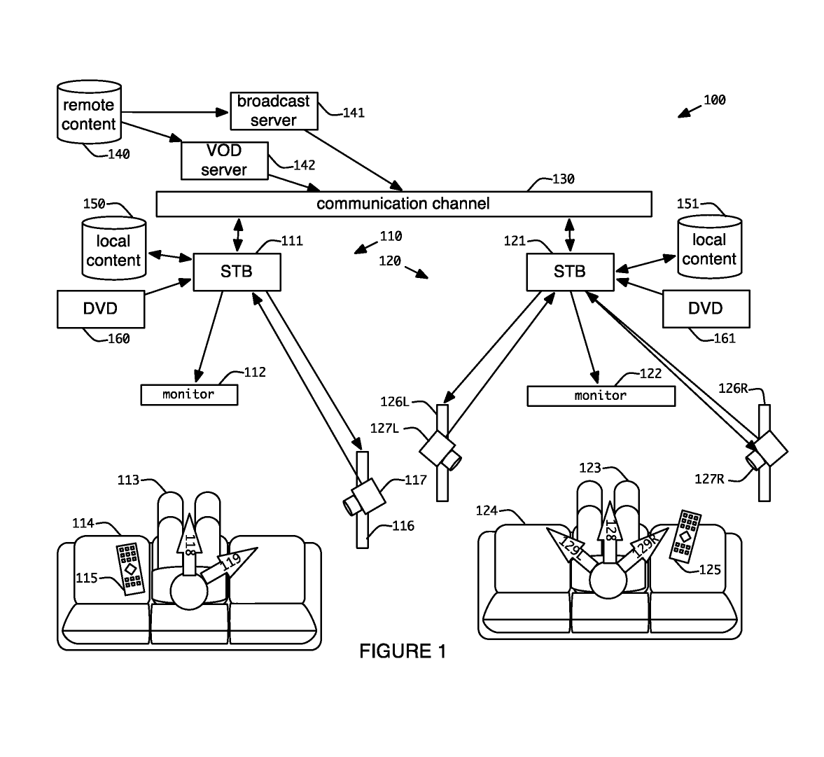

FIG. 1 depicts an exemplary embodiment of an audience telepresence system 100 that accomplishes the display of video content simultaneously among local audience members at different stations and the display of the images of remote audience members for viewing by local audience members. The telepresence system 100 of FIG. 1 comprises a pair of stations 110 and 120 connected via a communication channel 130, such as the Internet and/or other network(s). Each of the stations 110 and 120 can exist, without limitation, in a living room, bedroom, den, or any other suitable space of a private residence. Alternatively, one or both stations could reside in a hotel room or other non-private establishment (e.g., a sports bar). Indeed, either or both of the stations could exist virtually anywhere. At of the each stations 110 and 120, local audience members 113 and 123, respectively sit on furniture (e.g., couches) 114 and 124, respectively, with ready access to their remote controls 115 and 125, respectively.

The station 110 includes a local shared content monitor 112 for display of shared content. Similarly, the station 120 includes a local shared content monitor 122 for display of shared content at that station. As discussed in detail below, the local share content monitor 122 at the station 120 will display the same content as, and in substantial synchronization with, the content displayed on the local shared content monitor 112 at station 110. The station 110 has a local telepresence monitor 116, which displays the image captured by a first remote telepresence image capture device 127L, in the form of a television camera or the like, at the station 120. (In this embodiment, the station 120 has at least a second telepresence image capture device 127R whose image remains unutilized by the station 110.) The station 120 includes a telepresence monitor 126L for displaying the image captured by the telepresence image capture device 117 at station 110. (The station 120 also includes a second telepresence monitor 126R but in this embodiment, that monitor does not display any images from the station 110).

In accordance with an aspect of the present principles, the “facing” (i.e., the orientation) of the local telepresence monitor and associated telepresence image capture device relative to the corresponding local shared content monitor at the local station influences the display of images of a remote audience member on the local telepresence monitor. For ease of discussion, the directions “left” or “right” refer to the orientation of the telepresence monitor/image capture device pair relative to the local shared content monitor at the same station. In the illustrated embodiment of FIG. 1, the terms “left” and “right” indicates that the telepresence monitor/image capture device pair at a given station lies to the left and right, respectively, of a local audience member as that audience member faces the local shared content monitor. For example, as observed by member 123, monitor 126L is to the “left” of shared content monitor 122.

Equivalently, these terms can also refer to the orientation of the local audience member as defined by his gaze relative to the telepresence monitor/image capture device pair as he watches the local shared content monitor, which is to say that from the point-of-view of the image capture device, the orientation is the direction the local audience member appears to be turned when watching the local shared content monitor, which would be to the left or right of the image capture device, and typically out of the field of view of the image capture device. For example, as viewed by image device 127L, member 123 would appear to have a gaze to the “left”, when seated member 123 is observing shared content monitor 122 along direction of view 128.

Still equivalently, these terms can also refer to the orientation of the local audience member with respect to each local telepresence monitor/image capture device pair, relative to the local shared content monitor. Thus, from shared content monitor 122, member 123 is to the “left” of telepresence monitor 126L and image capture device 127L.

Use of one or another of these bases for orientation may be preferred when providing instructions for the assembly, or identifying the configuration, of systems such as those described herein. However, those skilled in the art will take from this discussion that they are geometrically equivalent and interchangeable.

Preferably, a microphone or other audio capture device (not shown) at the station 110 captures audio from the local audience member 113 at that station for play out through speakers or other audio reproduction (not shown) preferably in or near one of the telepresence monitors 126L or 126R at the station 120 for reception by the local audience member 123 (with 126L preferred in this embodiment). Likewise, a microphone or other audio capture device (not shown) at the station 120 captures audio from the local audience member 123 for play out through speakers or other audio reproduction devices (not shown), preferably in or near the telepresence monitor 116 at the station 110 for reception by the local audience member 113 at that station. In alternative embodiments, the microphones could reside anywhere within their respective stations 110 and 120 and the speakers (not shown) could reside at locations other than in or near the corresponding telepresence monitors. For example, in one embodiment, one or more speakers could reside in a surround sound array (not shown) driven by a set top box (STB) at a local station for reproducing audio from the microphone at the remote station.

Each of the stations 110 and 120 can access content for sharing from a variety of sources. For example, both of the stations 110 and 120 could access content from a remote content source 140 through one of a broadcast server 141 or a video-on-demand (VOD) server 142, both linked to the communication channel 130. The stations 110 and 120 could each include a separate one of local content storage devices 150 and 151, respectively, for local content storage and subsequent downloading or streaming to a remote station for sharing. Further, each of the stations 110 and 120 can include a separate one of DVD players 160 and 161, respectively, serving as a local source of shared content. In addition, each of the STBs 111 and 121 at the stations 110 and 120, respectively, can include provisions for accepting content from other sources (not shown), such as lap top computers and smart phones for example, operated by a corresponding one of local audience members 113 and 123, respectively.

Regardless of the source of the content, each of the STBs 111 and 121 has the ability to accept content for display on the corresponding local shared content monitor. In some embodiments, an STB may have the ability to stream content to, for receipt by, the STB at the other station (with or without buffering) for display on its associated local shared content monitor. If desired, a local STB can take account of all or part of the total delay caused by transport latency to, and the buffering undertaken by, a remote STB by locally imposing a delay before play out begins on the local shared content monitor. This reduces the temporal disparity between what the local audience members 113 and 123 experience as they view the shared content.

In the event that a local STB (e.g., STB 111) streams locally available content on the local content storage device 150 or the DVD player 160 to a remote STB (e.g., STB 121), both the local and remote STBs could implement a distributed transport (such as taught in U.S. Pat. No. 6,653,345 to Redmann et al., and U.S. Pat. No. 7,318,051 to Redmann). Using such a distributed transport approach, each local STB would accept transport commands, for example pause, forward, and rewind commands, entered by a local audience member via the member's remote control. The local STB would distribute such commands to the remote STB for substantially simultaneous execution. In this way, the play out of shared content at each station remains substantially synchronized, regardless of the transport commands entered by the local audience members 113 and 123. A similar distribution of transport control can occur in connection with content streamed from the broadcast server 141 or the VOD server 142. Each of the STBs 111 and 121 will share among themselves the content control commands received from their respective local audience members before issuing such commands to the broadcast server 141 and the VOD server 142.

In accordance with the present principles, the telepresence system 100 of FIG. 1 takes account of the number telepresence monitors at each station and their relative orientation to the associated telepresence image capture devices when generating display information to provide to each local audience member a psychological impression of a common space (that is, to provide an improved illusion of telepresence). In the illustrated embodiment of FIG. 1, the telepresence image capture device 117 will directly face the local audience member 113 when that audience member looks in the direction 119 toward the telepresence monitor 116. Under such circumstances, the image displayed on telepresence monitor 126L will depict the remote audience member 113 as looking toward local audience member 123. Likewise, when the local audience member 123 looks in direction 129L (toward image capture device 127L), the telepresence monitor 116 will depict the image of the remote audience member 123 as looking toward the local audience member 113. In other words, the remote audience member 123 appears to look out from the telepresence monitor 116.

When the local audience member 113 looks in the direction 118 (toward the local shared content monitor 112), the image displayed on the telepresence monitor 126L depicts the remote audience member 113 as looking towards the local shared content monitor 122, since the image capture device 117 captures a partial profile of the local audience member 113 who is actually watching shared content monitor 112, to provide the illusion of looking toward local shared content monitor 122. Likewise, when the local audience member 123 looks in the direction 128 (toward the local shared content monitor 122), the partial profile captured by the image capture device 127L, when displayed on telepresence monitor 116, appears to show the remote audience member 123 looking toward the local shared content monitor 112, even though audience member 123 is really watching shared content monitor 122. This arrangement produces an improved illusion for both audience members 113, 123, that the two stations 110 and 120 coexist in a telepresence-induced superposition. This perception survives even if the local shared content monitors 112 and 122 have radically different sizes or lie at different spacings from the corresponding local audience members 113 and 123. For the audience members, the illusion of viewing the shared content at a common location is strong and improved over prior telepresence systems.

A similar effect, that remote audience member 123 is looking out from the telepresence monitor 116, occurs when that monitor displays the view from the image capture device 127R while the local audience member 123 looks in the direction 129R. However, when the audience member 123 looks toward the local shared content monitor 122 (in the direction 128), the image of the remote audience member 123 depicted on the monitor 116 (without further processing, e.g., horizontal flipping) will show remote audience member 123 as looking away from the local shared content monitor 112, thus violating the telepresence illusion that the two stations 110 and 120 coexist in superposition. If however, the image from remote image capture device 127R were flipped horizontally before display on local telepresence monitor 116, then local audience member 113 should find the telepresence illusion compelling.

At the stations 110 and 120 of the telepresence system 100 of FIG. 1, the telepresence monitor/telepresence image capture device pairs 116/117 and 126L/127L, respectively lie on opposite sides of their corresponding local audience members 113 and 123. In other words, at the station 110, the telepresence image capture device 116/telepresence monitor 117 pair lies to the right of the local audience member 113. Conversely, the telepresence image capture device 126L/telepresence monitor 127L pair at station 120 lies to the left of the local audience member 123. This configuration supports the perception on the part of the local audience member of a shared, commonly shaped space in which the remote local audience member appears to share viewing of the local shared content monitor (e.g., local shared content monitors 112 and 122) with the corresponding local audience members 113 and 123, respectively, without requiring the images of each member 113, 123 to be flipped horizontally. However, if monitor/telepresence device pairs 116/117 and 126R/127R were to be used to produce a telepresence experience instead, since each pair lies to the same (right) side of their respective audience member 113, 123, the images of each member would need to be flipped horizontally to support the telepresence illusion.

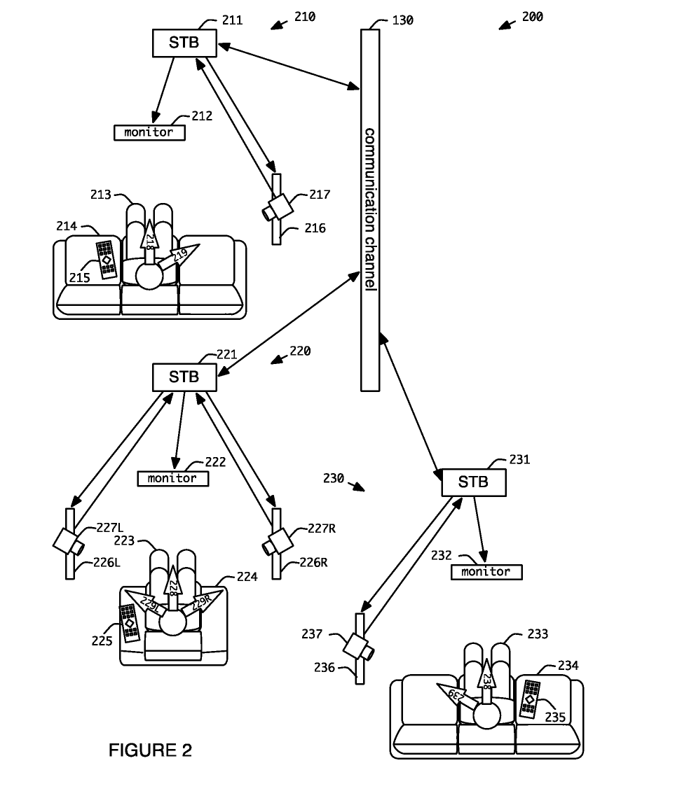

FIG. 2 depicts an alternate preferred embodiment 200 of a telepresence system comprising three stations 210, 220, and 230. The stations 210, 220 and 230 include set-top boxes 211, 221, and 231, respectively; shared content monitors 212, 222, and 232, respectively, telepresence monitors 216, 226L and 266R, and 236L and 236R, respectively, and telepresence image capture devices 217, 227 and 237. At each of the stations 210, 220, and 230, local audience members 213, 223 and 233, respectively, sit on furniture 214, 224, and 234, respectively. The local audience members 213, 223, and 233 utilize their remote controls 215, 225, and 235, respectively, to enter commends to a corresponding one of the STBs 211, 221 and 231, respectively. Each of the local audience member 213, 223, and 233 looks in a respective one of the forward directions 218, 228, and 238 to view their individual shared content monitors 212, 222, and 232 respectively. The local audience members 213 and 223 both look rightward in a respective one of directions 219 and 229R to view the corresponding one of the telepresence monitors 216 and 226R, respectively. Conversely, the local audience members 223 and 233 both look leftward in a direction 229L and 239, respectively, to view his/her corresponding telepresence monitors 226L and 236.

The telepresence system 200 of FIG. 2 includes two stations 210 and 220 configured with telepresence monitors 226L and 236 on the same side (e.g., the left side) of the seating position of the local audience members 223 and 233, respectively. With this arrangement of telepresence monitors in the telepresence system 200 of FIG. 2, the image from the image capture device 217 (on the right side of audience member 213) will be displayed on the telepresence monitor 226L will depict the local audience member 213 as facing correctly, that is, facing toward the shared content monitor 222 when he is actually watching shared content monitor 212. Correspondingly likewise when displayed on telepresence monitor 236. In contrast, were that image displayed on the telepresence monitor 226R, it would depict the remote audience member 213 facing the wrong way, that is, the image of remote audience member 213 would face away from shared content monitor 222. In accordance with the present principles, the local or remote STBs 221, 211 can resolve this problem by flipping the video from the telepresence image capture device 217 horizontally if display on telepresence monitor 226R is selected or required.

Several techniques exist for assuring proper display of the image of the remote audience member participant 213 at the station 220. For example, the “sending” STB (e.g., the STB 211 transmitting the image of the local audience member 213) can notify the “receiving” STBs (e.g., the STBs 221 and 231 receiving such image), that the single telepresence image capture device (e.g., the telepresence image capture device 217) associated with the sending STB lies to the right of the local audience member (e.g., to the right of the local audience member 213). This notification can comprise part of the transmitted image (e.g., as image metadata) or as part of the information provided during an initial configuration transaction. This orientation information about the telepresence image capture device 217 allows the receiving STB (e.g., STB 221) to process the image from that remote image capture device and determine the appropriate telepresence monitor for display, in this case the telepresence monitor 226L. As discussed above, with the image capture image capture device 217 lying to the right of the local audience member 213 at the station 210 in FIG. 2, the image of that local audience member should appear on the left-facing telepresence monitor (e.g., telepresence monitor 226L) at the station 220 to assure correct facing. At the station 230, the STB 231 would make this same choice, routing the image (e.g., video signal) received from the station 210 to the telepresence monitor 236 lying to the left of the local participant 233, since as this constitutes the only option at the station 230. Alternatively, the STB 221 could route the image to the telepresence monitor 226R after flipping the image horizontally (left-to-right). For any number of connections to the remote STBs, a sending STB need only send one formatted image. This approach affords an advantage when using an intermediate fan-out server (not shown) that replicates the video from one source and forwards it (unchanged) to each recipient station.

As an alternative, each receiving STB (e.g., STBs 221 and 231) could alert the sending STB (e.g., the STB 211) of the configuration of the receiving STB's associated telepresence image capture device(s). As an example, the STB 221 at the station 220 could indicate that its associated telepresence monitors 226L and 226R lie to the left and right, respectively, of the local audience member 223. The STB 231 would alert the STB 211 that station 230 possesses a single telepresence monitor 236 lying to the left of local audience member 233 in FIG. 2. Using such information, the STB 211 can decide, before sending the images (e.g., the video signals) from its associated image capture device 217 to the STB 221 or STB 231, whether to flip the image from left-to-right so that the image has the correct orientation for display at the station 221 (where either orientation remains viable) and at the station 231 where no flip needs to occur prior to display of that image on the telepresence monitor 236. This approach affords the advantage that all inbound images can have the correct orientation and be ready for display on at least one telepresence monitor. However, this approach incurs the disadvantage that the sending STB 211 might need to create two different streams, one right-facing and one flipped to be left-facing for oppositely arranged rooms (not shown).

A third approach obviates the need to share orientation information: Each sending STB (e.g., STB 211) will flip the image from its corresponding telepresence image capture device (e.g., image capture device 227) or not so that the image matches a predetermined orientation configuration, for example, an orientation in which the image capture device lies to the right of corresponding local audience member (e.g., local audience member 213). For the station 210, this corresponds to the correct orientation. All receiving STBs (e.g., STBs 221 and 231) assume this predetermined configuration, and act accordingly for the received images (e.g., video signals) from the transmitting STB. In the case of the station 230, since the actual monitor 236 lies to the left of local viewer 233, the STB 231 does not need to flip any received images video (regardless of the source). In this third approach, achieving a configuration change remains a local issue. If a setting representing the local configuration of the STB becomes mis-set, but later corrected, the setting change and altered behaviors remain strictly local. This remains the case even though the correction results in images coming from properly configured remote stations now showing correctly, and the outbound video sent to those remote stations containing such images also now appearing correctly.

Using this third approach, were another station (not shown) configured similar to the station 210, with only one telepresence monitor located to the local audience member's right (as with the telepresence monitor 216), then the corresponding receiving STB would need to flip any received images (e.g., telepresence video signals) but not any outbound images. Further, this third approach requires the STB 221 at the station 200 to make a decision whether to display received images on the left-side monitor 226L as-is, or flip them horizontally and display them on the right-side monitor 226R. This latter choice becomes particularly valuable if the received images (e.g., telepresence video signals) identify themselves as having been flipped at the source, because the STB 221 can then “un-flip” the images for display on the right-side monitor 226R in their original form.

The following caveat applies regardless of which of the above-described three approaches controls the video display. At station 220, the images sent to the other stations, for example station 210, should originate from the image capture device 227L or 227R corresponding to the telepresence monitors used for local display of images from those stations (e.g., if device 227L is used to capture the images being sent to station 210, then collocated display 226L should be used to display the images received from station 210). This selection of images remains crucial to supporting the illusion of eye contact between two local audience members speaking with each other within the telepresence system 200. Otherwise, whenever the local audience member 223 looks toward the displayed image of the audience member 213, the audience member 213 will see the back of local audience member's 223 head displayed on the telepresence monitor 216.

At the station 220, the STB 221 can send two telepresence video streams, namely the left-side stream from video image capture device 227L, and the right-side stream from video image capture device 227R. To avoid the need for horizontal flipping, the STB 211 can send the right stream from image capture device 227R sent to the station 230 so the STB 231 can display that image on the left-side monitor 236. The STB 221 can send the stream from the image capture device 227L to the station 210 at which the STB 211 can display that image on the right-side monitor 216. Correspondingly, the STB 221 will display the images from the remote right-side image capture device 217 at station 210 on the local telepresence monitor 226L at station 220. Likewise, the STB 221 will display the images from the remote left-side image capture device 237 at station 230 on the local telepresence monitor 226R at station 220.

Assume for purposes of discussion that the telepresence system 200 included a fourth station (not shown) configured like the station 220. In other words, such a fourth station would include two telepresence monitors lying on the left and right sides, respectively, of the corresponding local audience member. In such a telepresence system, three possible modes could exist for handling video sent by the station 220. In the first mode, the STB 221 would only send the left-side video stream from the image capture device 227L to the additional station, which would display the video on its right-side monitor (not shown). In a second possible mode, the STB 221 might send only the right-side video stream from image capture device 227R to the additional station, which would display the stream on its left-side monitor (not shown). In a third mode, the STB 221 could make both the left and right-side streams available, with the receiving station deciding which of the two streams to display on the correspondingly opposite side monitor.

The STB at each station having multiple telepresence monitors (e.g., 226L and 226R at station 220) could make the decision of what side will display the image of a remote audience member based on the local audience member's preference, the remote audience member's preference, and/or an automatic system allocation, for example based on predetermined policies. If given the choice, a local audience member could choose to display telepresence video from the remote station on one particular side, e.g., to the right, for example because of a bigger monitor, or a less bright backdrop on that side (e.g., no window). The remote audience member sending his or her image to others might prefer being photographed by a particular image capture device because of better lighting on that side, a better backdrop, or the remote audience member might prefer being photographed from a particular side (e.g., the remote audience member's “good side.”) Automatic allocation could occur because the telepresence system 200 of FIG. 2 has a policy in place that attempts to equalize the number of remote participants appearing on one side vs. the other. For example, the telepresence system could have a policy that does not permit a first screen to display more than two remote participants until the opposite screen has displayed at least two participants. Under other circumstances, the telepresence system 200 might not allow adding a new remote participant to a first monitor if that monitor already carries more participants than the other monitor.

Further, the telepresence system 200 could have a policy of preferring correct facing images (e.g., telepresence video signals) over horizontally flipped images, where such a choice exists. For example, a remote STB could accept the images from either of the image capture devices 227L and 227R, or the local STB 221 could display the remotely sourced images on either monitors 226L or monitor 226R. Note that the choice made by one STB for either alternative will compel the corresponding choice in the other—that is the image capture device used must correspond to the telepresence monitor used. Collectively, STBs may take account of sender and receiver preferences as well as system policies to determine on which side a particular remote participant should appear (e.g., on monitor 226L vs. monitor 227L). An STB can make such decisions dynamically. For example, if two remote participants drop from one monitor, the local STB may move at least one excess participant to the other, less crowded monitor. This can give rise to a disconcerting virtual movement of a particular local audience member from one side of the room to the other. The STB could make a decision to shift images only when a new local audience member joins the telepresence group.

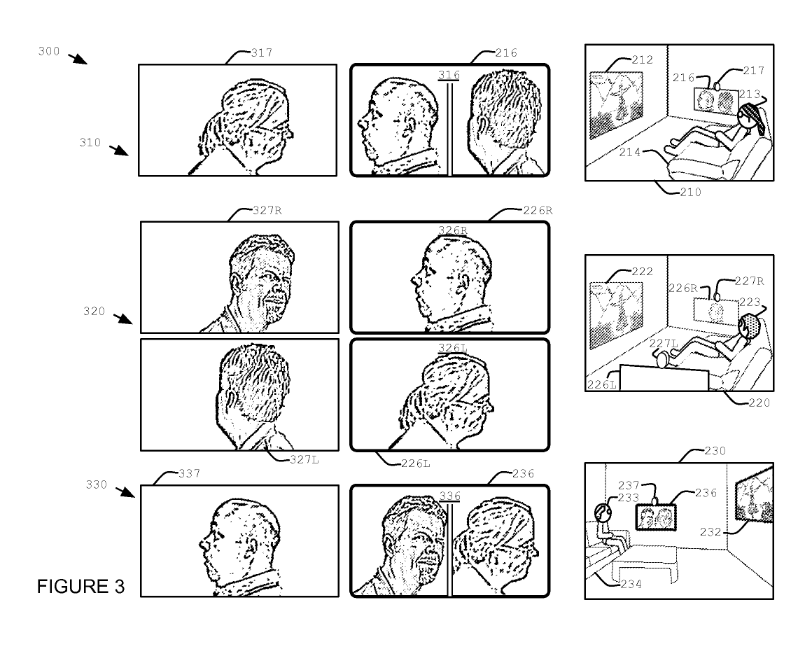

FIG. 3 depicts the results from of implementing these three ways of managing the distribution and display of images from image capture devices 217, 227L, 227R, 237. The image set 300 represents the combination of the substantially simultaneous local image sets 310, 320, 330 at each of corresponding locations 210, 220, and 230. At station 210, the image set 310 comprises the image 317 of local audience member 213 as captured by telepresence image capture device 217. Likewise, at station 220, the image set 320 comprises the image 327R and 327L of local audience member 223 as captured by telepresence image capture devices 227R and 227L (respectively). At the station 230, the image set 330 comprises the image 337 of local audience member 233 as captured by telepresence image capture device 237. At each of the stations 210, 220, and 230, the corresponding shared content monitors 212, 222, and 232, respectively, display the same video program in substantial synchronization with each other.

Each of the image sets 310, 320, and 330 also comprise one or more local images containing video information from a remote telepresence image capture device at each of the respective remote stations. With regard to the image set 310 representing the activity at the station 210, the monitor 216 shows an image 316 comprising a composition of images from image capture devices 227L and 237. With regard to the image set 320 at station 220, each of the monitors 226R and 226L display respective images 326R and 326L obtained from image capture devices 237 and 217, respectively. Regarding the image set 330 at the station 230, the monitor 236 displays an image 336, comprising a composition of images from remote image capture devices 227R and 217. In this example case, none of the images undergoes flipping.

Under other circumstances, a STB may flip the images from a remote telepresence image capture device. However, this will only occur when: (a) two stations, connected to each other, each possess one image capture device and telepresence monitor (e.g., both stations have a “telepresence monitor on the right” configuration like station 210), or b) for some reason of preference or policy (as described above), an image from a particular telepresence image capture device at a remote station (e.g., on the right) undergoes display on the same side (that is, on the right) in a station (e.g., 220) that has two telepresence monitors disposed on either side.

The image 316 displayed on the telepresence monitor 216 comprises one panel showing at least a portion of an unflipped image 337, and a second panel showing at least a portion of unflipped image 327L. The image 326R on telepresence monitor 226R comprises one panel showing at least a portion of unflipped image 337, while the image 326L on telepresence monitor 226L comprises one panel showing at least a portion of unflipped image 317. The image 336 on the telepresence monitor 236 comprises two panels, each showing at least a portion of the image 317 and 327R, neither of which has undergone horizontal flipping. The portions of the images 317, 327L, 327R and 337 shown in the panels of the image 316, 326L, 326R, and 336, whether flipped horizontally or not, can undergo cropping and/or scaling to achieve aesthetic goals of filling the allocated portion of the screen, and/or appearing believably life-sized.

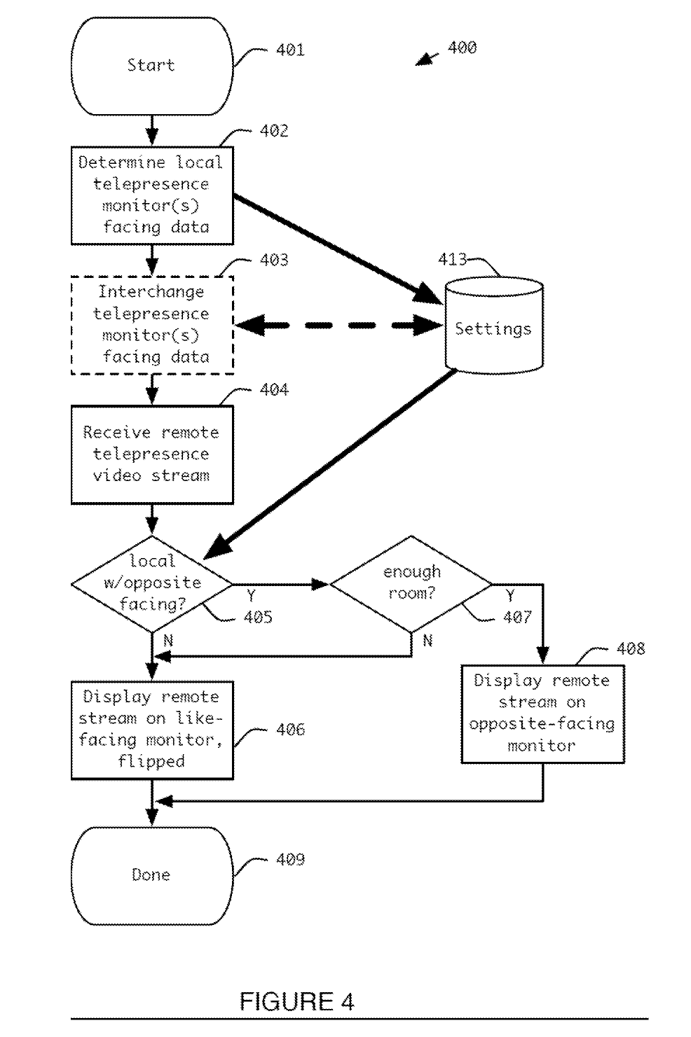

FIG. 4 depicts in flowchart form an exemplary telepresence video reception process 400 suitable for use with stations 210, 220, 230, which begins at step 401 with the local image capture devices (e.g., 227L and 227R), the local telepresence monitors (e.g., 226L and 226R), and the local STB (e.g., STB 221) ready, and connected to one or more remote stations (e.g., 210, 230) through the communications channel 130. At step 402, the local STB obtains the facing data representing the substantially coincident location of local telepresence monitor (e.g., the telepresence monitor 226L) and corresponding image capture device (e.g., the image capture device 227L). The STB can obtain such data by displaying instructions to the local audience member (e.g., local audience member 223) asking about the position of at least one specific telepresence monitor and image capture device relative to local shared content monitor (e.g., local content monitor 222) and processing the local audience member's response, such as by monitoring his or her remote control (e.g., remote control 225). The local STB (e.g., STB 221) could obtain or infer the relative position of another monitor (if any, e.g., monitor 226R) and the corresponding image capture device (e.g., the image capture device 227R) as being the opposite of the first position. The local STB (e.g., 221) will then record the facing data for each monitor (e.g., monitors 226L and 226R) and the corresponding image capture devices (e.g., image capture devices 227L and 227R) in settings database 413.

In telepresence systems that exchange facing data corresponding to the local or remote telepresence monitors, such an exchange occurs step 403. In those embodiments, which require the facing data of the remote telepresence monitors (e.g., monitors 216 and 236) in order to properly select the display monitor (e.g., monitors 226L or 226R) for each of the inbound images (e.g., video signals), the local STB receives such facing data during step 403 and stores such information in a database 413. In those embodiments where an STB (e.g., 221) or a fan-out server (not shown) provides a video stream already formatted for the facing of each remote telepresence monitor (e.g., monitors 216 and 236), the STB exchanges facing data with remote stations (210 and 230) or the fan-out server (not shown), during step 403. In some instances, the facing data can exist as embedded as metadata within the video signals sent and received.

In some embodiments, the effective facing of all video signals being sent within system 200 have a predetermined conventional facing and both sending and receiving systems will horizontally flip the outbound or inbound images (e.g., video signals) as needed relative to their own actual configuration (as discussed above). Under such circumstances, step 403 becomes unnecessary, allowing skipping of that step, with no changes needed to the database 413. However, this can mean that the local STB (e.g., STB 221) will provide two streams, each from a different one of image capture devices 227L and 227R. Thus, the streams have opposite natural facings (as in the example images 327L and 327R of FIG. 3), so that the image for one of the two streams will need undergo horizontal flipping: Which of these two streams undergoes flipping should be noted, for example within the video stream itself as metadata, to enable giving preference (where desired and/or possible), to an unflipped presentation, whether that means using the unflipped stream as-is, or flipping the flipped stream.

During step 404, the local STB (e.g., the STB 221) receives the video stream from a remote STB (e.g., STBs 211 and 231) corresponding to one remote image capture device (e.g., image capture devices 217 and 237). During step 405, the local STB determines whether a local monitor (e.g., monitors 226L or 226R) has a facing the opposite of that remote image capture device (e.g., image capture devices 217 and 237). If so, then during step 407, the local STB makes a further determination whether adequate room exists on the local telepresence monitor screen to display this stream, according to whatever preferences or policies might be used. If so, then during step 408, the local STB (e.g., STB 221) displays the remote video stream (e.g., the remote audience member images from the remote telepresence image capture devices) on the monitor having the opposite facing. Note that in the absence of step 407 (that is, no check is made for adequate room), step 408 will follow step 406. If during step 405, the local STB determines that no monitor exists with a facing opposite to that of the incoming video stream or if during step 407, the local STB seeks minimize crowding on the opposite facing monitor (or based upon another preference and/or policy basis), then at step 406, the local STB will flip the image (e.g., the video stream) horizontally and display the image on the monitor having the same facing as the image source. In the case where a remote station (not shown) has two telepresence monitors (similar to station 220), and can provide two video streams, one from either of the corresponding image capture devices, the local STB (e.g., the STB 221) can decide during step 406 to make use of the second stream instead, without flipping, rather than horizontally flipping the image in the first stream. The video reception process 400 concludes at step 409.

Under conditions when the local STB has two telepresence monitors (as at station 220) and receives the facing data associated with the remote monitors 216 and 236 from the remote telepresence STBs 211 and 231, respectively, during step 403, then at step 405, the local STB (e.g., the STB 221) will select the appropriately oriented monitor (e.g., monitor 226L or 226R, respectively). Under conditions where each of the remote STBs (e.g., the STBs 211 and 231) delivers a video stream having a standard image orientation, then at a station (e.g., the station 220) where telepresence monitors (e.g., telepresence monitors 226L and 226R) remain available on either side of the local audience member (e.g., the audience 223), then in advance of step 405, the local STB (e.g., the STB 221) will make a further check (not shown) to determine what the natural orientation of the received video stream would be. If the received stream remains unflipped before being sent in conformance with a standard facing, then processing proceeds as normal during step 405. If not, that is, if the received video had undergone flipping to conform to a standard facing, then the local STB (e.g., the STB 221) may flip the video again, prior to 405, step (not shown). Now, processing can proceed by noting that the facing does not conform to the standard facing during step 405, but is now correct. In such an embodiment, the local STB will give preference to presenting unflipped video with the appropriate facing, whenever practical. Note that in cases where “unflipping” would occur only to be followed based on processing by “reflipping” during step 406, then greater efficiency could occur by looking ahead and foregoing the computational expense of the double flip.

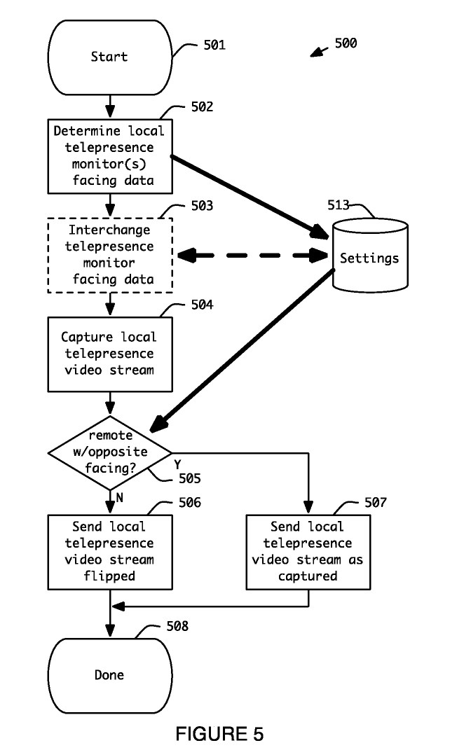

FIG. 5 illustrates in flowchart form, an exemplary process 500 for sending telepresence video to remote stations. The process 500 of FIG. 5 begins at step 501 with the local image capture devices (e.g., the image capture devices 227L and 227R), the local telepresence monitors (e.g., the monitors 226L and 226R), and the local STB (e.g., the STB 221) ready and connected to one or more remote stations (e.g., stations 210 and 230) through communications channel 130. During step 502, the local STB (e.g., STB 221) will obtain facing data representing each of the substantially coincident locations of the local telepresence monitor/image capture device pairs (e.g., monitor/image capture device pairs 226L/227L, and 226R/227R), for example by instructions displayed and viewer input obtained described in conjunction with step 402, above. For example, a local telepresence monitor (e.g., monitor 226L) could display an arrow generated by the local STB (e.g., the STB 221). The local audience member (e.g., the local audience member 223) could make adjustments, using his or her remote control (e.g., remote control 225) as needed to flip the arrow until it points rightward to the content monitor (e.g., the monitor 222. Likewise, the local audience member would adjust an arrow displayed on a local telepresence monitor (e.g., the monitor 226R) to point the arrow leftward toward the local content monitor (e.g., the monitor 222). The local STB (e.g., the STB 221) will record the facing data so obtained in a settings database 513 to indicate that the monitor (e.g., the monitor 226L) and the corresponding local image capture device (e.g., image capture device 227L) lie to the left of the local shared content monitor (e.g., the monitor 222) in this example.

Should a need exist to exchange the facing data corresponding with either the local or remote telepresence monitors, such an exchange occurs during step 503. Under circumstances where the facing data indicative of the facing of the remote telepresence monitors (e.g., the monitors 216 and 236) becomes necessary in order to properly flip horizontally the corresponding outbound video signals (e.g., the images of the local image capture devices), the local STB (e.g., the STB 221) will receive such facing data during step 503 and store the data in the database 513. Under circumstances where the remote STBs (e.g., the STBs 211 and 231) or a fan-out server (not shown) expect to receive a common video signal from the local station (e.g., the station 220), the local STB (e.g., the STB 221) sends the facing data for the local telepresence monitors (e.g., monitors 226L and 226R) from the database 513 to the remote stations (e.g., the stations 210 and 230) during step 503. In some instances, the facing data can exist as metadata within the video signals sent and received. Otherwise, in the image set where the effective facing of all video signals being sent within the telepresence system 200 has a presumed predetermined conventional facing, both sending and receiving stations will horizontally flip the outbound or inbound video signals as needed relative to their own actual configuration (as discussed above in conjunction with FIG. 2). Under such circumstances, step 503 becomes unnecessary, with no changes to the database 513. The video stream can include metadata indicating whether the image (e.g., the video signal) has undergone horizontal flipping. During step 504, the local STB (e.g., the STB 221) will accept the video signals from the local telepresence image capture device or devices (e.g., the image capture devices 227L and 227R),

Under circumstances where the sending station (e.g., the station 220 of FIG. 2) has the obligation to provide video from the local telepresence image capture devices (e.g., the image capture devices 227L and 227R) already formatted for display at on the remote telepresence monitors (e.g., the monitors 216 and 236), then during step 505, the local STB (e.g., STB 221) determines whether the facing data associated with each remote telepresence monitor (e.g., monitors 216 and 236) indicates that those monitors face opposite to a local telepresence image capture device (e.g., image capture devices 227L and 227R). If so, then the local STB selects the video feed from that correspondingly opposite image capture device during step 505 and during step 507, the local STB (e.g., STB 221) sends the selected, oppositely oriented video stream for transmission to that remote station. For example, remote station 230 having a telepresence monitor 236 on the left would result in local STB 221 selecting at 505 the video stream from local image capture device 227R, on the right to be sent to remote station 230. If at 505 there is found to be no opposite facing monitor at the remote station, or convention requires a facing different than for that provided in the local capture at 504, then the stream to be sent at 506 is horizontally flipped. Process 500 concludes at 508.

In the illustrative embodiment of FIG. 2, if a local audience member is imaged from both sides, as in the case of the local audience member 223 covered from the right and left by the image capture devices 227L and 227R, respectively, then the local STB (e.g., the STB 221) will typically not need to perform step 506, usually choosing instead to send whichever of the two streams needs no flipping. Rather, only a local STB at a station (e.g., station 210) having a single image capture device (e.g., image capture device 217) on a first side (right), for sending to a remote station having a telepresence monitor on the same side (none shown), needs to perform step 506. An exception to this may occur at dual-monitor stations (e.g., 220) if, for instance, the local participant (e.g., 223) has indicated a preference for being imaged from a particular side, or if the monitor on the appropriate side already has too many remote participant images allocated to it.

In some circumstances, an expectation exists that all transmitted telepresence video sent has conventional facing data, i.e., all stations (e.g., stations 210, 220, and 230) should flip the telepresence video from the local telepresence image capture devices (e.g., image capture devices 217, 227L, 227R, 237) as needed, to appear as if they were located to a predetermined common side (e.g., to the right) of the corresponding shared content monitors (e.g., monitors 212, 222, and 232). In light of such an expectation; then determination that occurs during step 505 will be replaced by a determination of whether an image capture device already lies on the correct side (as with the image capture devices 217 and 227R) or whether the image capture device does not lie on the predetermined common side (e.g., to the left, as with the image capture devices 227L and 237). When the facing data for the local telepresence monitor and corresponding image capture device already matches the conventional facing, then the local STB (e.g., the STB 221) sends the images (e.g., the video stream from the image capture devices 217 and 227R) as collected during step 507. However, if the local facing data does not match the conventional facing data, then, during step 506, the local STB will flip the local telepresence images horizontally before sending such images to the remote stations (as would be the case with image capture devices 227L and 237).

Under circumstances when, during step 503, the local STB (e.g., 221) sends the facing data for local monitor (e.g., monitors 226L and/or 226R) to the remote STBs (e.g., the STBs 211 and 231, with the expectation that these remote STBs will select or format the video stream they receive before displaying it, the determination made during step 505 becomes unnecessary and the process proceeds through to step 507, because the remote station STBs will select or manipulate video obtained during step 504 as needed for display on remote telepresence monitors (e.g., monitors 216 and 236). Alternatively, during step 505, the local STB (e.g., STB 221) can select the appropriate images (i.e., video streams) for each remote station (e.g., the stations 211 and 231).

With respect to the various possibilities for the video reception process 400 of FIG. 4 and the video sending process 500 of FIG. 5, the specific embodiments made and policies selected should produce agreement such that, with respect to a particular remote station, the selection of which local telepresence monitor will display the remote telepresence images corresponds to the selection of which local telepresence image capture device images stream for transmission to, and display by that same remote station. This ensures that, when a first audience member (e.g., audience member 223) looks toward a displayed telepresence image of a second, remote audience member (e.g., audience member 213) facing him or her, the second audience member receives an image of the first audience member turned toward him or her as well (rather than, say, seeing the back of the audience member's head) as illustrated in the several examples present in FIG. 3.

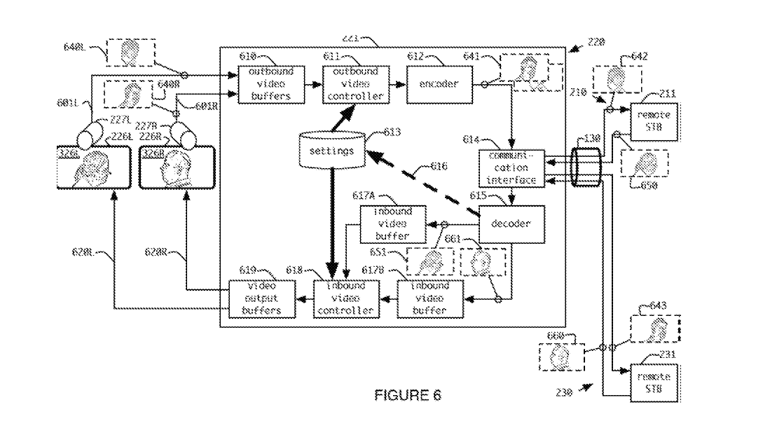

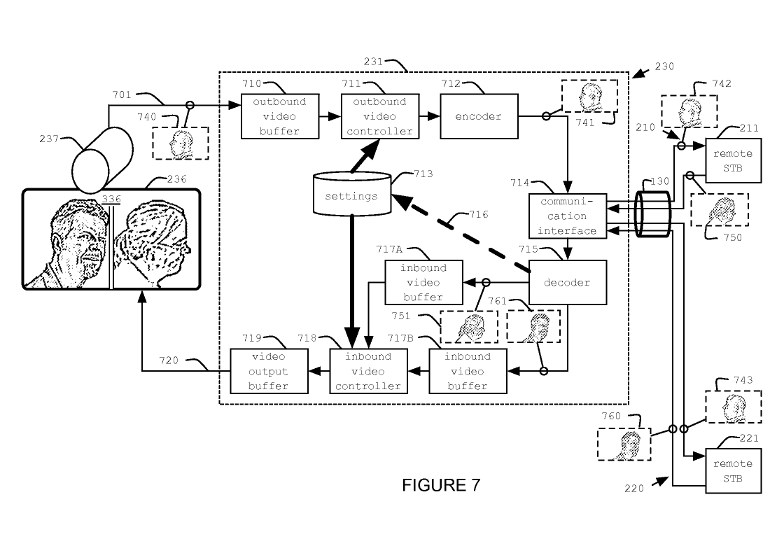

FIGS. 6 and 7 depict schematic diagrams of exemplary embodiments of the portions of the STBs 221 and 231, respectively, for implementing the telepresence activities in the system 200 of FIG. 2. Referring to FIG. 6, at the station 220, the telepresence image capture devices 227L and 227R provide video output signals 601L and 601R, which carry video images 640L and 640R, respectively. The STB 221 receives the video output signals 601L and 601R, which contain the video images 640L and 640R acquired by the outbound video buffers 610. (The term “outbound” in this context designates video destined for remote stations).

An outbound video controller 611 accesses the video data from video buffers 610 in accordance with configuration data stored in a settings database 613. In this example, the telepresence monitor/image capture device pair 226R/227R lies to the right side of the local audience member 223 and telepresence monitor/image capture device pair 226L/227L lie to the left (as shown in FIG. 2), being the appropriate orientation for the configuration recorded in the database 613. Thus, the outbound video controller 611 passes the video originated by at least one of the image capture devices to an encoder 612 for encoding, preferably with the information of which of images 640L and 640R represents the left-side and the right-side image, respectively. Depending up the specific embodiment, the outbound video controller 611 may flip one or the other outbound image based on this information (or, in rare instances, both). Thus, the encoded video images 641 pass from the encoder 612 to a communication interface 614 for transmission via communication channel 130 to each of remote STBs 211 and 231 as telepresence image streams 642 and 643, respectively.

In this exemplary illustration, each of image streams 642 and 643 comprise a selected one of the encoded video images 641. In alternative embodiments, one or both of streams 642 and 643 may comprise both of encoded video images 641. Similarly, one or the other of streams 642 and 643 may comprise a horizontally flipped version of the corresponding image. Each of remote STBs (e.g., the STBs 211 and 231) send corresponding telepresence image streams 650 and 660, respectively, via the communication channel 130, for receipt by the local STB (e.g., STB 221) via its communication interface 614. These inbound telepresence streams pass from the communication interface 614 to a decoder 615. The decoder 615 distinguishes between each of inbound streams 650 and 660 and processes them as telepresence image data 651 and 661, respectively, for writing to the inbound video buffers 617A and 617B, respectively. If the decoder 615 recognizes any remote station configuration metadata 616, the decoder stores such data in the database 613 for use in the operation of the video controllers 611 and 618.

An inbound video controller 618 accesses at least a portion of video data from video buffers 617A and 617B for writing to video output buffers 619. The inbound video controller 618 accesses the video buffers 617A, 617B and writes to video output buffer 619 in accordance with configuration data from the database 613, including in particular which, if any, of the inbound images 651, 661 needs horizontal flipping. The video buffers will output the video signals 620L and 620R for display on the corresponding telepresence monitors 226L and 226R as images 326L and 326R, respectively.

In view of the settings recorded in the database 613 within the STB 221, in the exemplary embodiment corresponding to FIGS. 2 and 3, neither of images 640L and 640R captured by telepresence image capture devices 227L and 227R, respectively require a horizontal flip before transmission to the remote STBs 211 and 231 as streams 642 and 643, respectively. Likewise, neither of inbound video streams 650 and 660 requires horizontal flipping, though if required, this embodiment could apply a horizontal flip during transfer of the video data from the inbound video buffers 617A and 617B to the video output buffers 619 by the inbound video controller 618. The result, as depicted for the location 220 in the image set 320 in FIG. 3, shows that the faces of remote local audience members 213 and 233 in images 326L and 326R on respective telepresence screens 226L and 226R seem to look toward the shared screen 222.

FIG. 7 depicts a block schematic diagram of the STB 231 associated with the station 230 of FIG. 2 and corresponding to image set 330 depicted in FIG. 3. At the station 230, the telepresence image capture device 237 provides a video output signal 701, which carries a video image 740. The STB 231 receives the video output signal 701 such that the video image 740 is acquired by outbound video buffer 710. An outbound video controller 711 accesses the video data from video buffer 710 in accordance with configuration data from the database 713. In this example, the telepresence monitor/image capture device pair 236/237 lies to the left side of the local audience member (the audience member 233, as shown in FIG. 2), corresponding to the configuration listed in the database 613. Thus, the outbound video controller 711 passes the video out to an encoder 712 with no horizontal flip. The encoder 712 passes the encoded video image 741 to a communication interface 714 for transmission via the communication channel 130 to each of the remote STBs (e.g., STBs 211 and 221 as telepresence image streams 742 and 743, respectively.

Each of remote STBs (e.g., STBs 211 and 221) send corresponding telepresence image streams 750 and 760, respectively, via the communication channel 130 to the STB 231 for receipt via the communication interface 714. These inbound telepresence streams pass from the communication interface 714 to a decoder 715. The decoder 715 distinguishes between each of inbound streams 750 and 760 and processes these as telepresence image data 751 and 761, respectively, written to the inbound video buffers 717A and 717B, respectively. If the decoder 715 recognizes any remote station configuration metadata 716, the decoder stores the data in the database 713 for used in the operation of the video controllers 711, 718. An inbound video controller 718 accesses at least a portion of video data from video buffers 717A and 717B for writing to a video output buffer 719. The inbound video controller 718 accesses the video buffers 717A and 717B and writes to the video output buffer 719 in accordance with configuration data from the database 713, including in particular which, if any, of the inbound images need horizontal flipping (which, in this example, is neither). The STB 231 outputs the video signal 720 from video output buffer 719 for display on the telepresence monitor 236 as image 336.

Since the station 230 only has the one telepresence monitor 236, the image streams 750, 760 from the connected remote stations 210, 220 must undergo compositing into a common image 336. As was earlier discussed in FIG. 6 but not shown, a similar condition may apply when, for example, two or more remote stations having the same configuration (e.g., the stations have their telepresence monitor and image capture device lying to the right of the corresponding local audience member). Under such circumstances the multiple images would undergo compositing to appear together on the opposite-side monitor 226L, unless during step 407, the left-side monitor has become too crowded, and one or more of the telepresence images becomes assigned to the right-side monitor 226R and undergoes horizontal flipping to retain the proper facing with respect to local shared content monitor 222.

With the orientation information recorded in the settings in database 713 (consistent with the example configuration shown in FIGS. 2 and 3), the image 740 captured by telepresence image capture device 237 receives no horizontal flip before transmission to the remote STBs (e.g., the 211 and 221). Similarly, for this example, both inbound video streams 750 and 760 have the correct facing and require no horizontal flip. The result, as illustrated in the image set 330 of FIG. 3 for the station location 230 of FIG. 2, shows that the faces of remote audience members 213 and 223 in image 336 on telepresence screen 236 generally facing toward local shared content screen 232.

Both FIGS. 6 and 7 further illustrate that when one local telepresence monitor displays the image from a particular remote station, the corresponding local telepresence image capture device will provide the image sent to for display at that remote station, as previously discussed.

The foregoing describes a technique for achieving improved image display in a telepresence system.

1. A method for processing images in a telepresence system, comprising the steps of:
establishing, at a first station within the telepresence system, first orientation data indicative of an orientation of a first user relative to each of a first and second image display devices at the first station;
receiving at the first station an incoming first image of a second user from a second station of the telepresence system, for which second orientation data is indicative of an orientation of the second user relative to a first image capture device at the second station is available; and
processing the first image for display on a selected one of the first and second image display devices, in accordance with the first and second orientation data so that upon display on the selected display device, the image of the second user appears to coexist in a telepresence-induced superposition with the first user in a common environment.

2. The method of claim 1 wherein the second orientation data is predetermined.

3. The method of claim 1 further comprising the step of:
receiving at the first station the second orientation data from the second station.

4. The method of claim 3 wherein the second orientation data comprises metadata associated with the incoming image.

5. The method of claim 1 wherein a first portion of the first orientation data corresponds to the said selected one of the first and second image display devices; the method further comprising the step of:
processing, at the first station, the first image, in accordance with the first and second orientation data; wherein,
if the first portion matches the second orientation data, then the processing includes flipping the first image horizontally, but no flipping occurs if the first portion does not match the second orientation data.

6. The method of claim 1 further comprising the steps of:
capturing a second image of the first user from a second image capture device, the second image capture device corresponding to said selected one of the first and second image display devices; and
transmitting the second image to the second station.

7. The method of claim 6 further comprising the step of:
transmitting at least a portion of the first orientation data to the second station.

8. The method of claim 6 wherein a first portion of the first orientation data corresponds to the second image capture device, the method further comprising the step of:
processing the second image at the first station, in accordance with the first and second orientation data before transmission to the second station; wherein,
if the first portion matches the second orientation data, then the processing includes flipping the first image horizontally, but no flipping occurs if the first portion does not match the second orientation data.

9. The method according to claim 1 wherein the processing step includes:
determining a status for each of the first and second image display devices;
selecting one of the first and second display devices to display the first images based on the status of each image display device.
horizontally flipping the first image depending on which of the first and second display devices is selected.

10. Apparatus at a first station for processing images in a telepresence system, comprising;
a database for storing first orientation data indicative of an orientation of a first user relative to each of a first and second image display devices at the first station;
a communications interface for receiving station an incoming first image of a second user from a second station of the telepresence system, for which second orientation data is indicative of an orientation of the second user relative to a first image capture device at the second station is available; and
processing means for processing the first image for display on a selected one of the first and second image display devices, in accordance with the first and second orientation data so upon display, the image of the second user appears to coexist in a telepresence-induced superposition with the first user in a common environment.

11. The apparatus of claim 10 wherein the second orientation data is predetermined.

12. The apparatus according to claim 10 of claim 1 wherein the communications interface also receives the second orientation data from the second station.

13. The apparatus of claim 12 wherein the second orientation data comprises metadata associated with the incoming image.

14. The apparatus of claim 10 wherein a first portion of the first orientation data corresponds to the said selected one of the first and second image display devices; and t wherein the processing means processes the first image, in accordance with the first and second orientation data; and if the first portion matches the second orientation data, then the processing means flips the first image horizontally, but no flipping occurs if the first portion does not match the second orientation data.

15. The apparatus of claim 10 wherein the processing means captures a second image of the first user from a second image capture device, the second image capture device corresponding to said selected one of the first and second image display devices; and transmits the second image to the second station.

16. The apparatus of claim 10 wherein the processing means transmits at least a portion of the first orientation data to the second station.

17. The apparatus of claim 10 wherein a first portion of the first orientation data corresponds to the second image capture device, and wherein the processing means processes the second image at the first station, in accordance with the first and second orientation data before transmission to the second station; and if the first portion matches the second orientation data, then the processing means flips the first image horizontally, but no flipping occurs if the first portion does not match the second orientation data.

18. The apparatus according to claim 10 wherein the processing means (a) determines a status for each of the first and second image display devices; (b) selects one of the first and second display devices to display the first images based on the status of each image display device, and (c) horizontally flips the first image depending on which of the first and second display devices is selected.
